(19) United States
(12) Patent Application Publication
(10) Pub. No.: US 2004/0128687 A1
(43) Pub. Date: Jul. 1, 2004

(54) Apparatus and method for reserve-recording broadcast program of television

(75) Inventor: Won Ho Chun, Seoul (KR)

Correspondence Address: Jonathan Y. Kang, LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/735,007

(22) Filed: Dec. 12, 2003

(30) Foreign Application Priority Data
Dec. 13, 2002 (KR) 79794/2002

(51) Int. Cl. H04N 7/173; G06F 13/00; H04N 5/445; G06F 3/00

(52) U.S. Cl. 725/58; 725/60; 725/61; 725/86

(57) ABSTRACT

An apparatus and method for reservedly recording a broadcast program of a television are disclosed. A broadcast program desired by a user can be reserve-recorded on the basis of a color code having broadcast program information quickly and conveniently.

### BACKGROUND OF THE INVENTION

1. Field of the Invention

The present invention relates to a television and, more particularly, to an apparatus and method for reserve-recording a broadcast program of a television.

2. Description of the Prior Art

Recently, as the television technologies are advancing, the analog televisions are increasingly substituted by digital televisions, and diverse functions are additionally installed in the digital television.

The digital television and a digital set-top box are anticipated to function as a core hub in building a home network.

Providing bi-directional data broadcast services, digital broadcasts allow a ground for many applications to be performed for users' convenience, and in line with the advent of the applications, an importance of various user interfaces is increasing.

Among a plurality of user interfaces, recording a desired broadcast program while watching a TV program is a basic function for users, and a lot of reserve-recording methods have been developed.

A method for reserve-recording a broadcast program desired by a user in accordance with a conventional art will now be described with reference to FIGS. 1 to 3B.

FIG. 1 is an exemplary view showing a reserve-recording menu for reserve-recording a user's desired broadcast program in accordance with a conventional art.

As shown in FIG. 1, in order to reserve-recording a desired broadcast program, a user should set both a recording start time and an end time of the broadcast program.

For example, the user should search a time zone of the desired broadcast program from a broadcast program table on a newspaper, set the recording start time and the ending time of the broadcast program, and check the set reserve-recording time. This is very complicate and inconvenient for the user.

In an effort to solve such a problem of the conventional art on the basis of FIG. 1, a method for reserve-recording a broadcast program by using a G-code will now be described with reference to FIG. 2.

FIG. 2 is an exemplary view showing a reserve-recording menu using a G-code in accordance with a conventional art.

As shown in FIG. 2, when the user inputs numbers for a desired broadcast program among various broadcast program, a recording start time and an ending time of the broadcast program are automatically inputted. This method can be more convenient than the reserve-recording method of FIG. 1, but with a problem that the user should personally input the numbers as many as 6˜7 digits.

To resolve the problems of the methods of FIGS. 1 and 2, a method for reserve-recording a broadcast program by using an EPG (Electronic Program Guides) will now be described with reference to FIGS. 3A and 3B.

FIGS. 3A and 3B are exemplary views showing a reserve-recording menu using the EPG in accordance with a conventional art, of which FIG. 3A shows a reserve-recording menu using the EPG and FIG. 3B shows a full info-window.

As shown in FIGS. 3A and 3B, the reserve-recording method using the EPG is performed as follows. An EPG is displayed on a screen of a digital TV in response to a user's request. When a broadcast program is selected from the displayed EPG by the user, a full-info window is displayed. When the user clicks a corresponding button in order to reserve-recording the selected broadcast program, information for reserve-recording the selected broadcast program is recorded in the reserve-recording list of the full-info window. When it's a reserve-recording time for the recorded broadcast program, the broadcast program recorded on the reserve-recording list is recorded.

However, with the method for reserve-recording a broadcast program by using the EPG in accordance with the conventional art, the user should perform a plurality of reserve-recording procedures in order to reserve-record a desired broadcast program, causing an inconvenience to the user and much time taken for searching a broadcast program to be reserve-recorded.

In addition, since the user can not be aware of EPG information on a channel of a broadcast program that the user is not watching, the corresponding channel should be tuned for the user to view a desired broadcast.

### SUMMARY OF THE INVENTION

Therefore, an object of the present invention is to provide an apparatus and method for reserve-recording a broadcast program of a television by which a user can reserve-record a desired broadcast program conveniently and quickly.

To achieve these and other advantages and in accordance with the purpose of the present invention, as embodied and broadly described herein, there is provided an apparatus for reserve-recoding a TV broadcast program, in which a desired broadcast program desired by a user is on the basis of a color code having broadcast program information.

To achieve the above objects, there is also provided an apparatus for reserve-recoding a TV broadcast program, including: a camera for photographing a color code having broadcast program information; an EPG database for previously storing EPG data; a cable modem for receiving EPG data corresponding to the photographed color code from the EPG database; a decoding unit for receiving reserve-recording information of a broadcast program desired to be recorded by a user from the EPG data received from the EPG database through the cable modem, and recording the read reserve-recording information on a reserve-recording list; and a user interface for outputting a message related to the reserve-recording information of the broadcast program and the reserve-recording list through an on-screen display on a screen.

To achieve the above objects, there is also provided a method for reserve-recording a TV broadcast program including: reserve-recording a broadcast program desired by a user on the basis of a color code having broadcast program information.

To achieve the above objects, there is also provided a method for reserve-recording a TV broadcast program including: photographing a color code having broadcast program information; reading EPG data corresponding to the photographed color code from a EPG database; parsing reserve-recording information of reserve-recording information of a broadcast program desired to be recorded by a user from the read EPG data; recording the parsed reserve-recording information on a reserve-recording list; and displaying a message related to the reserve-recording information and the reserve-recording list on a screen.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing a reserve-recording menu for reserve-recording a user's desired broadcast program in accordance with a conventional art;

FIG. 2 is an exemplary view showing a reserve-recording menu using a G-code in accordance with a conventional art.

FIGS. 3A and 3B are exemplary views showing a reserve-recording menu using the EPG in accordance with a conventional art;

FIGS. 4A and 4B are exemplary views showing a color code and a gray code adopted for an apparatus and method for reserve-recording a broadcast program of a television in accordance with the present invention;

FIG. 5 is a block diagram showing a construction of the apparatus for reserve-recording a TV broadcast program in accordance with the present invention; and

FIG. 6 is a flow chart of a method for reserve-recording a TV broadcast program in accordance with the present invention.

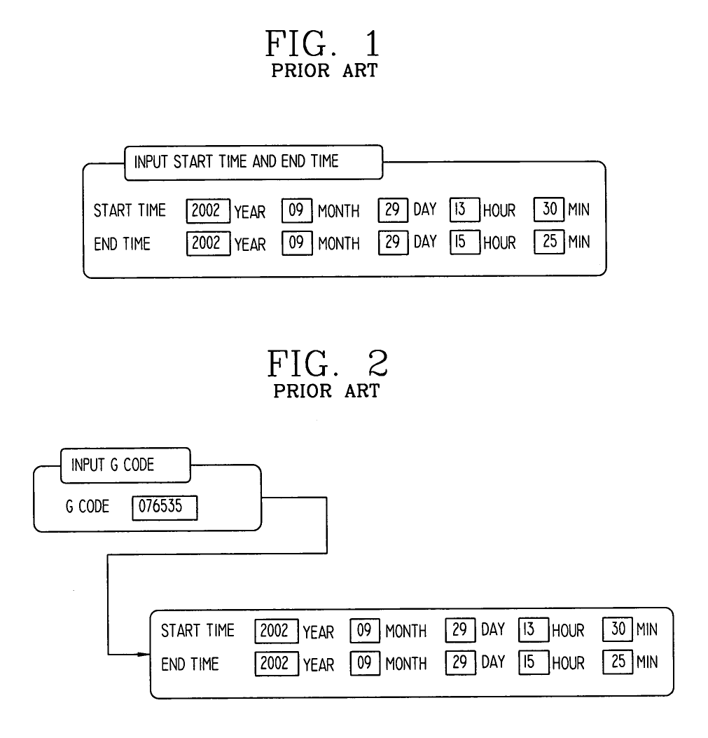

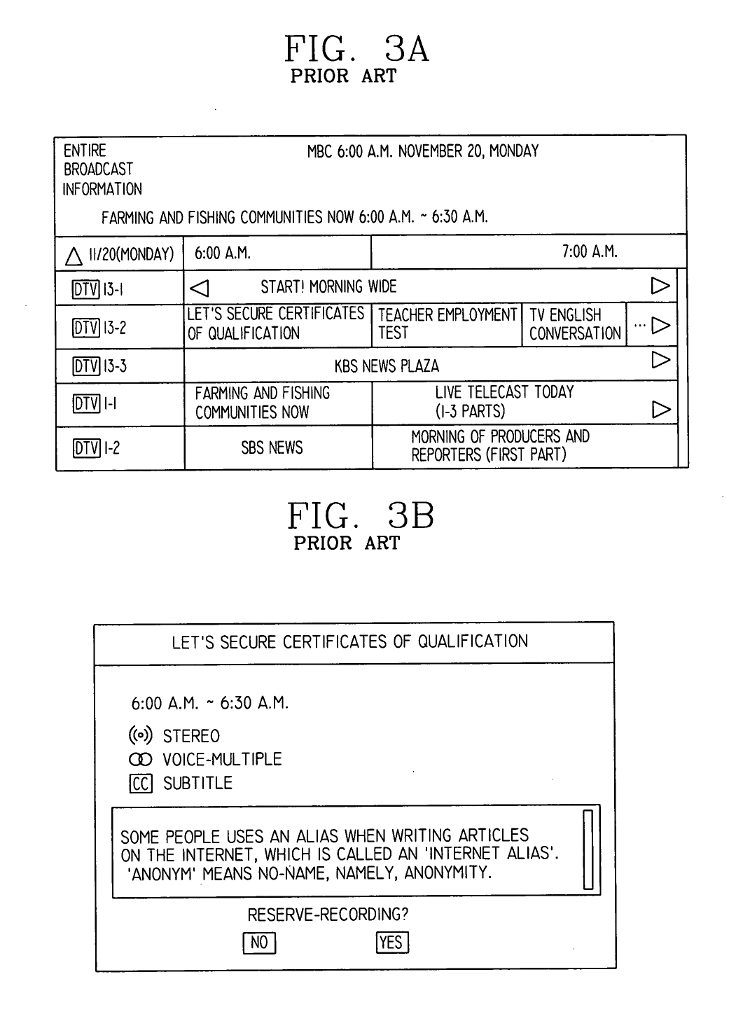

### DETAILED DESCRIPTION OF THE PREFERRED EMBODIMENTS

Reference will now be made in detail to the preferred embodiments of the present invention, examples of which are illustrated in the accompanying drawings.

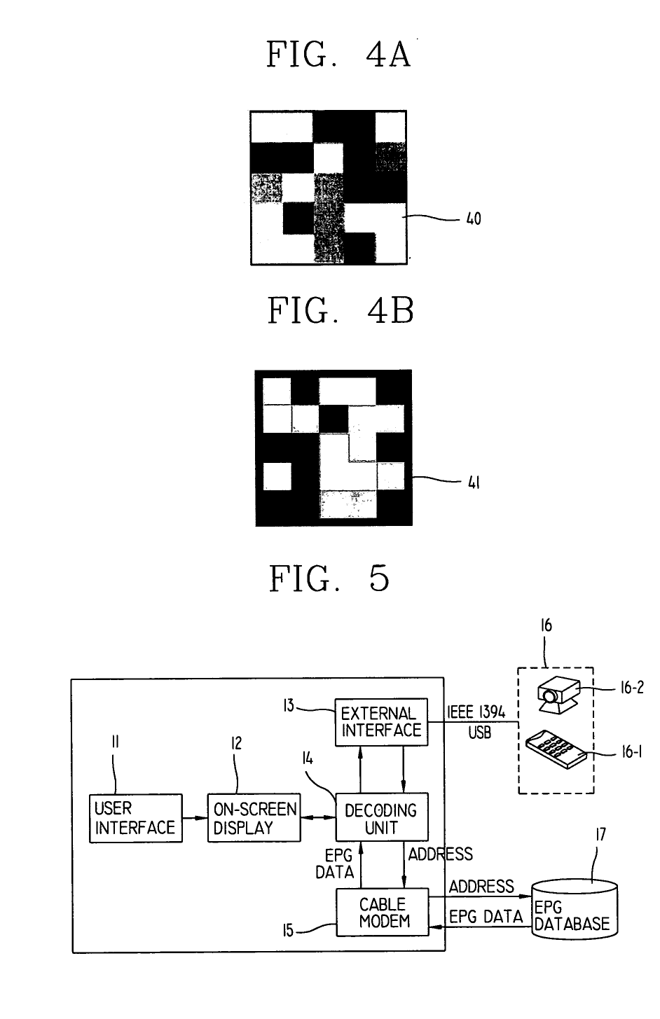

An apparatus and method for reserve-recording a TV broadcast program capable of allowing a user to reserve-record a desired broadcast program conveniently and quickly on the basis of a color code having broadcast program information of a digital TV in accordance with a preferred embodiment of the present invention will now be described with reference to FIGS. 4A to 6.

The color code has broadcast program information such as a specific EPG value.

FIGS. 4A and 4B are exemplary views showing a color code and a gray code adopted for an apparatus and method for reserve-recording a broadcast program of a television in accordance with the present invention.

With reference to FIG. 4A, a currently developed gray code 40, featuring an advancement of the existing barcode, is a code that can recognize various information by generating about 17 billion or more patterns by using fourth colors (e.g., red, green, black and blue colors) at a 5×5 square matrix, and even more patterns can be created by increasing the number of cells of the color code.

With reference to FIG. 4B, a gray code 41 is a clod that can recognize various information by generating about 86 million or more patterns by using two colors (e.g., black and white colors) at the 5×5 square matrix, and even more patterns can be created by increasing the number of cells of the gray code.

In the present invention, a user can reserve-record quickly and conveniently a desired broadcast program on the basis of the color or the gray code having broadcast program information.

The color code is used in the field such as a printing media, an image media, an off-line business or a commercial/public information. In addition, application of the color code to newspapers is generalized.

In the present invention, the application field of the color code is extended to the digital TV, by which the user can easily and quickly reserve-record a TV broadcast program. The color code adopted for the apparatus and method for reserve-recording a TV broadcast program has broadcast program information and can be inserted in newspapers or magazines running a broadcast program table.

The apparatus for quickly and easily reserve-recording a TV broadcast program on the basis of the color code will now be described with reference to FIG. 5.

FIG. 5 is a block diagram showing a construction of the apparatus for reserve-recording a TV broadcast program in accordance with the present invention.

As shown in FIG. 5, the apparatus for reserve-recording a TV broadcast program includes a camera 16; an external interface 13 connected to the camera 16 and receiving a color code photographed by the camera 16; an EPG database 17 for previously storing EPG (Electronic Program Guide) data; a cable modem 15 for receiving EPG data corresponding to a value of the photographed color code from the EPG database 17; a decoding unit 14 for receiving the EPG data corresponding to the color code value through the cable modem 15, parsing reserve-recording information (e.g., a broadcast date and broadcast time) of a broadcast program desired to be recorded by a user from the received EPG data, and recording the parsed reserve-recording information on a reserve-recording list; and a user interface 11 for outputting a message related to the reserve-recording information of the broadcast program and the reserve-recording list through an on-screen display 12 on a screen.

The decoding unit 14 recognizes a pattern of the photographed color code transferred through the external interface 13, and performs an error verification on the recognized pattern.

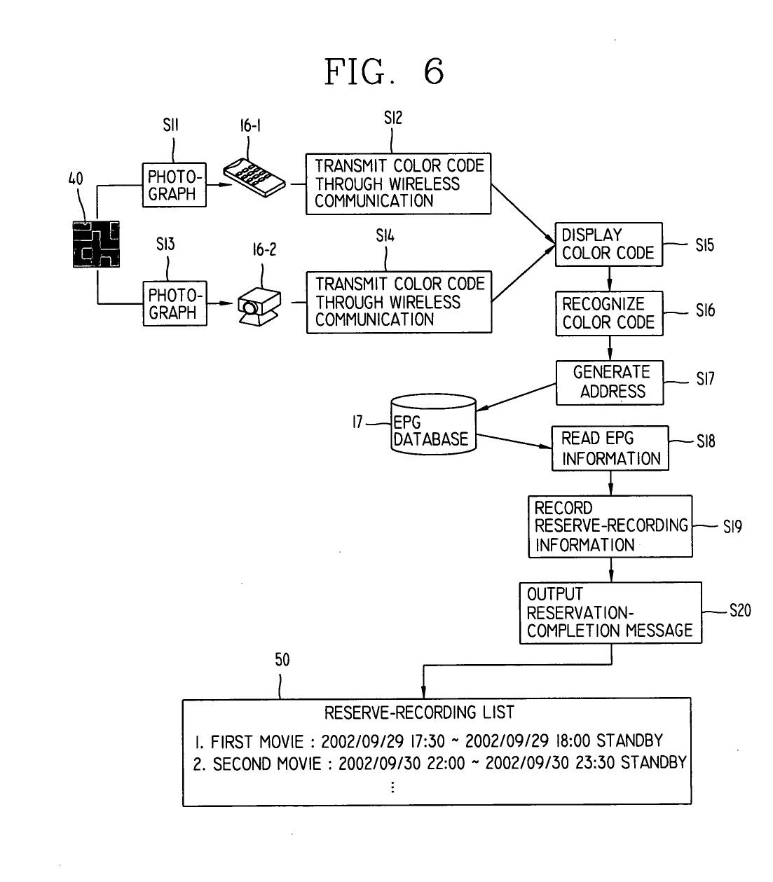

A method for reserve-recording a TV broadcast program in accordance with the present invention will now be described in detail with reference to FIG. 6.

FIG. 6 is a flow chart of a method for reserve-recording a TV broadcast program in accordance with the present invention.

As shown in FIG. 6, the method for reserve-recording a TV broadcast program includes: photographing a color code having broadcast program information; previously storing EPG data in an EPG database; reading EPG data corresponding to a value of the photographed color code from the EPG database; parsing reserve-recording information of a broadcast program desired to be recorded by a user from the read EPG data; recording the parsed reserve-recording information on a reserve-recording list; and displaying a message related to the reserve-recording information on a screen.

The step of reading the EPG data corresponding to the value of photographed color code includes: generating an address indicating the EPG data corresponding to the photographed color code, and reading the EPG data corresponding to the generated address from the EPG database.

The parsed reserve-recording information includes a broadcast date, a broadcast time, a name of the broadcast program, or the like. That is, the parsed reserve-recording information refers to information required for the user to reserve-record a broadcast program desired to be recorded, including date information (day, month and year) on when the broadcast program is aired, time information (e.g., a recording start time and an ending time of the broadcast program), a name of the broadcast program, and can include any additional information.

The present invention will now be described in detail on the assumption that color code is photographed from a TV broadcast guide book or newspapers having a color code with corresponding broadcast program information printed thereon.

First, the camera 16 photographs a color code 40 having the broadcast program information, and transmits the photographed color code 40 through a wireless communication or a wired communication to the decoding unit 14 of the digital TV 10 (steps S11˜S14). Herein, the color code 40 can be photographed by using a computer camera 16-2, or after a rotary-type camera is inserted in a remote controller 16-1 controlling a TV, the color code 40 can be photographed through the rotary-type camera.

When the color code 40 is photographed by using the computer camera 16-2, a USB (Universal Serial Bus) or an IEEE1394 interface can be used.

In the case that the color code 40 is photographed by installing the rotary-type camera in the remote controller 16-1 controlling a TV, a rotary-type camera having a function of controlling a focal point is preferably used.

For example, the camera installed in the remote controller is rotated to photograph the color code, and the photographed color code is transmitted to the decoding unit 14 of the television 10. Then, upon recognizing the color code, the decoding unit 14 parses reserve-recording information of a broadcast program desired to be recorded by the user from the EPG information corresponding to the recognized color code, and records the parsed reserve-recording information on the reserve-recording list.

In addition, the color code 40 can be also photographed by using a bluetooth built-in camera (not shown). For example, by photographing the color code 40 through the bluetooth-installed camera, the photographed color code 40 can be transmitted to the digital TV 10 through a wireless communication.

Subsequently, the color code photographed by the camera 16 is transmitted to the decoding unit 14 through the external interface 13 of the television.

The decoding unit 14 displays the color code photographed by the camera on a screen of the digital TV (step S15). At this time, the user can adjust the camera 16 so as for the color code 40 to be positioned at a pre-set recognition region while viewing the color code 40 displayed on the screen.

Thereafter, the decoding unit recognizes the photographed color code through a recognition program stored therein (step S16), generates an address for reading EPG data corresponding to the value of the recognized color code, and transfers the generated address to the cable modem 15 (step S117).

Then, the cable modem 15 reads the EPG data indicated by the address generated by the decoding unit 14 from the EPG database 17, and transfers the read EPG data to the decoding unit 14 (step S18). In other words, the cable modem 15 reads the reserve-recording information of the broadcast program desired to be recorded by the user from the EPG data corresponding to the color code, and transmits the read reserve-recording information to the decoding unit 14.

The decoding unit 14 parses the reserve-recording information of the user-desired broadcast program from the EPG data received from the EPG database through the cable modem 15, and records the parsed reserve-recording information on the reserve-recording list (step S19).

After recording the parsed reserve-recording information on the reserve-recording list, the decoding unit 14 displays a message ‘reservation completed’ through the on-screen display 12 on the screen of the digital TV 10 (step S20). In this respect, the message related to the reserve-recording information (e.g., the message of ‘reservation completed’ is preferably displayed for two seconds.

Thereafter, the decoding unit 14 displays the reserve-recording list 50 on the screen through the user interface 11 so that the user can check and edit the reserve-recording information of the broadcast program as recorded on the reserve-recording list 16. When it reaches a reserve-recording time of the broadcast program recorded on the reserve-recording list 50, the broadcast program recorded on the reserve-recording list is recorded.

Meanwhile, besides the reserve-recording, in the present invention, the color code can be also applied as follows.

That is, when a color code is transmitted from a broadcasting station to a TV, the color code displayed on the screen of the TV can be photographed by a camera so as to show detailed information of a corresponding broadcast program through the user interface.

In addition, the function of the color code can be further extended such that, by photographing a color code displayed on the screen of the TV through the camera, detailed goods information and mutually compared goods information in a TV home-shopping can be viewed through the user interface on the spot while viewing the TV.

For example, goods information is additionally stored in the EPG database. At this time, the decoding unit recognizes a pattern of the color code or the gray code, reads an index value connected to the color code or the gray code, reads a Web page corresponding to the information indicated by the read index value from the EPG database, and displays the Web page on the screen. The information indicated by the index value may include a Web address, and the Web page includes descriptions on goods.

As so far described, the apparatus and method for reservedly recording a broadcast program of a television in accordance with the present invention have the following advantages.

That is, for example, first, by reserve-recording a user-desired broadcast program on the basis of a color code having broadcast program information, the user can reserve-record the desired broadcast program conveniently and quickly.

Second, by simply photographing only the color code through the camera, the user can reserve-record a desired broadcast program.

Third, since the user photographs only the color code through the camera, the reserve-recording process is simple compared to the conventional method, and in addition, a reserve-recording list can be easily checked without manipulation of a remote controller.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for reserve-recoding a broadcast program of a television, wherein a broadcast program desired to be recorded by a user is reserve-recorded on the basis of a color code having broadcast program information.

2. The apparatus of claim 1, wherein reserve-recording information of the user-desired broadcast program is read from EPG (Electronic Program Guide) data corresponding to the color code and the read reserve-recording information is recorded on a reserve-recording list of the television.

3. The apparatus of claim 2, wherein the read reserve-recording information is recorded on the reserve-recording list, and a reserve-recording completion message and the reserve-recording list are displayed on a screen.

4. The apparatus of claim 1 comprising:
a means for photographing a color code or a gray code having the broadcast program information;
a means for storing the EPG (Electronic Program Guide) data; and
a means for receiving EPG data corresponding to the value of the photographed color code or gray code from the EPG data storing means, parsing the user-desired reserve-recording information from the received EPG data; and recording the parsed reserve-recording information on the reserve-recording list.

5. The apparatus of claim 4 further comprising:
a means for outputting a message relate to the reserve-recording information of the broadcast program on a screen.

6. The apparatus of claim 4, wherein the reserve-recording information of the broadcast program is a broadcast date and a broadcast time of the broadcast program.

7. A method for reserve-recording a broadcast program of a television comprising:
reserve-recording a user-desired broadcast program on the basis of a color code or a gray code having broadcast program information.

8. The method of claim 7, wherein the step of reserve-recording a user-desired broadcast program comprises:
reading reserve-recording information of the user-desired broadcast program from EPG (Electronic Program Guide) data corresponding to the color code or the gray code; and
recording the read reserve-recording information on a reserve-recording list of the television.

9. The method of claim 8, wherein the step of reserve-recording a user-desired broadcast program further comprises:
recording the read reserve-recording information on the reserve-recording list, and then displaying a reserve-recording completion message and the reserve-recording list on a screen.

10. The method of claim 7, wherein the step of reserve-recording a user-desired broadcast program comprises:
photographing a color code or a gray code having the broadcast program information;
previously storing the EPG data;
receiving EPG data corresponding to a value of the photographed color code or gray code from a means which previously stores the EPG data;
parsing reserve-recording information of the user-desired broadcast program from the received EPG data; and
recording the parsed reserve-recording information on the reserve-recording list.

11. The method of claim 10 further comprising:
displaying a message related to the reserve-recording information on a screen.

12. The method of claim 10, wherein the reserve-recording information of the broadcast program is a broadcast date and a broadcast time of the broadcast program.

13. An apparatus for reserve-recoding a TV broadcast program, comprising:
a camera for photographing a color code having broadcast program information;
an EPG (Electronic Program Guide) database for previously storing EPG data;
a cable modem for receiving EPG data corresponding to the photographed color code from the EPG database;
a decoding unit for receiving reserve-recording information of a broadcast program desired to be recorded by a user from the EPG data received from the EPG database through the cable modem, and recording the read reserve-recording information on a reserve-recording list; and
a user interface for outputting a message related to the reserve-recording information of the broadcast program and the reserve-recording list through an on-screen display on a screen.

14. The apparatus of claim 13, wherein the reserve-recording information of the broadcast program is a broadcast date and a broadcast time of the broadcast program.

15. The apparatus of claim 13, wherein the decoding unit generates an address indicating EPG data corresponding to the color code photographed by the camera through an external interface, and the cable modem reads EPG data corresponding to the generated address from the EPG database and transmits the read EPG data to the decoding unit, and then, the decoding unit parses reserve-recording information of the broadcast program desired to be recorded by a user from the received EPG data and records the parsed reserve-recording information on the reserve-recording list.

16. A method for reserve-recording a TV broadcast program comprising:
photographing a color code having broadcast program information;
reading EPG (Electronic Program Guide) data corresponding to the photographed color code from a EPG database;
parsing reserve-recording information of reserve-recording information of a broadcast program desired to be recorded by a user from the read EPG data;
recording the parsed reserve-recording information on a reserve-recording list; and
displaying a message related to the reserve-recording information and the reserve-recording list on a screen.

17. The method of claim 16, wherein the reserve-recording information of the broadcast program is a broadcast date and a broadcast time of the broadcast program.

18. The method of claim 16, wherein the step of reading the EPG data corresponding to the photographed color code comprises:
generating an address indicating the EPG data corresponding to the photographed color code; and
reading the EPG data corresponding to the generated address from the previously stored EPG database.
